(19) United States
(12) Patent Application Publication
(10) Pub. No.: US 2022/0187811 A1
(43) Pub. Date: Jun. 16, 2022

(54) ABNORMALITY DIAGNOSIS SYSTEM, ABNORMALITY DIAGNOSIS METHOD, AND PROGRAM

(71) Applicant: TOYOTA JIDOSHA KABUSHIKI KAISHA, Toyota-shi (JP)

(72) Inventors: Misato SHIMADA, Toyota-shi (JP); Takahisa YAMAKAWA, Toyota-shi (JP); Ryo MIZUNO, Miyoshi-shi (JP); Shun SATO, Nagoya-shi (JP); Daisuke NORITAKE, Nagoya-shi (JP)

(73) Assignee: TOYOTA JIDOSHA KABUSHIKI KAISHA, Toyota-shi (JP)

(21) Appl. No.: 17/523,512

(22) Filed: Nov. 10, 2021

(30) Foreign Application Priority Data
Dec. 14, 2020 (JP) 2020-206729

(51) Int. Cl. G05B 19/418; G06T 7/00

(52) U.S. Cl. CPC G05B 19/41875; G05B 19/4183; G06T 7/0004

(57) ABSTRACT

An abnormality diagnosis system includes an image acquisition unit and an abnormality determination unit. The image acquisition unit acquires a circuit image to be diagnosed which is an image visually representing a logical circuit in a control apparatus that controls an apparatus in a facility and a control state in the logical circuit, and is a subject of an abnormality diagnosis. The abnormality determination unit determines whether or not there is a deviation between the circuit image to be diagnosed acquired by the image acquisition unit and a normal circuit image, which is a circuit image in a state in which a facility related to the control apparatus corresponding to the circuit image to be diagnosed is in a normal state. The abnormality determination unit determines that an abnormality has occurred in the facility when it is determined that there is a deviation.

### CROSS REFERENCE TO RELATED APPLICATIONS

This application is based upon and claims the benefit of priority from Japanese patent application No. 2020-206729, filed on Dec. 14, 2020, the disclosure of which is incorporated herein in its entirety by reference.

### BACKGROUND

The present disclosure relates to an abnormality diagnosis system, an abnormality diagnosis method, and a program.

In a factory for manufacturing bodies of automobiles or the like, predetermined operations such as welding and painting are performed by using facilities (i.e., apparatuses) such as industrial robots. In such facilities, operations are performed by using devices such as motors, brakes, and speed reducers. In such facilities, it is desired to perform an abnormality diagnosis for facilities (e.g., determine whether an abnormality has occurred in the facilities) in order to prevent troubles such as an accidental stop of the facilities during the operations.

As a technique related to the above-described technical matters, Japanese Unexamined Patent Application Publication No. 2020-101904 discloses a control apparatus that controls an object to be controlled during a production process. The control apparatus disclosed in Japanese Unexamined Patent Application Publication No. 2020-101904 calculates one or a plurality of feature values from one or a plurality of state values acquired from an object to be monitored included in the object to be controlled. The control apparatus disclosed in Japanese Unexamined Patent Application Publication No. 2020-101904 performs one of a plurality of algorithms for calculating a score, which is a value indicating a possibility of some abnormality occurring in the monitoring target (i.e., the object to be monitored), based on the calculated feature values. The control apparatus disclosed in Japanese Unexamined Patent Application Publication No. 2020-101904 generates a determination result indicating whether or not some abnormality has occurred in the monitoring target based on the calculated score.

### SUMMARY

There are a large number of facilities (i.e., apparatuses) in a manufacturing factory, and control circuits of these facilities may be different from one another. Therefore, when the abnormality diagnosis for these facilities is performed, it is necessary to set a different algorithm for each of the facilities. Therefore, in the technique disclosed in Japanese Unexamined Patent Application Publication No. 2020-101904, when the abnormality diagnosis for the facilities is performed, it is necessary to diagnose each of the facilities by using a different method.

An object of the present disclosure is to provide an abnormality diagnosis system, an abnormality diagnosis method, and a program capable of performing an abnormality diagnosis for facilities without using a different method for each of the facilities.

A first exemplary aspect is an abnormality diagnosis system including: an image acquisition unit configured to acquire a first circuit image, the first circuit image being a circuit image visually representing a logical circuit for control in a control apparatus and a control state in the circuit, and being a subject of an abnormality diagnosis, the control apparatus being configured to control an apparatus in a facility; and an abnormality determination unit configured to determine whether or not there is a deviation between the first circuit image acquired by the image acquisition unit and a normal circuit image, and determine, when it is determined that there is a deviation, that an abnormality has occurred in the facility, the normal circuit image being the circuit image in a state in which the facility related to the control apparatus corresponding to the first circuit image is in a normal state.

Another exemplary aspect is an abnormality diagnosis method including: acquiring a first circuit image, the first circuit image being a circuit image visually representing a logical circuit for control in a control apparatus and a control state in the circuit, and being a subject of an abnormality diagnosis, the control apparatus being configured to control an apparatus in a facility; and determining whether or not there is a deviation between the acquired first circuit image and a normal circuit image, and determining, when it is determined that there is a deviation, that an abnormality has occurred in the facility, the normal circuit image being the circuit image in a state in which the facility related to the control apparatus corresponding to the first circuit image is in a normal state.

Another exemplary aspect is a program causing a computer to perform: acquiring a first circuit image, the first circuit image being a circuit image visually representing a logical circuit for control in a control apparatus and a control state in the circuit, and being a subject of an abnormality diagnosis, the control apparatus being configured to control an apparatus in a facility; and determining whether or not there is a deviation between the acquired first circuit image and a normal circuit image, and determining, when it is determined that there is a deviation, that an abnormality has occurred in the facility, the normal circuit image being the circuit image in a state in which the facility related to the control apparatus corresponding to the first circuit image is in a normal state.

In the present disclosure, since it is possible to perform an abnormality diagnosis by comparing images, it is possible to perform an abnormality diagnosis for a plurality of facilities without setting a different algorithm for each of their control apparatus. Therefore, it is possible to perform an abnormality diagnosis for facilities to detect an abnormality thereof without using a different method for each of the facilities.

Further, when it is determined that an abnormality has occurred in the facility, the abnormality determination unit may determine whether or not the circuit in the first circuit image differs from that in the normal circuit image, and when it is determined the circuit in the first circuit image differs from that in the normal circuit image, the abnormality determination unit may determine that the circuit has been tampered with in the control apparatus.

Under normal conditions, the circuit is not altered (e.g., changed) during the control of the control apparatus. The fact that the circuit nevertheless differs from that in the normal state means that there is a very high possibility that the circuit has been tampered with. Therefore, according to the present disclosure, by the above-described configuration, it is also possible to diagnose the facility as to the type of the abnormality, such as tampering of the circuit.

Further, when it is determined that an abnormality has occurred in the facility, but it is determined that the circuit in the first circuit image does not differ from that in the normal circuit image, the abnormality determination unit may determine that the abnormality has occurred because an operating condition has not been satisfied in the circuit.

The situation in which the first circuit image differs from the normal circuit image, but the circuits do not differ from each other is a situation in which the control state in the first circuit image differs from that in the normal circuit image. Therefore, according to the present disclosure, by the above-described configuration, it is possible to appropriately detect an abnormality that has been caused by the fact that an operating condition has not been satisfied in the circuit. Further, the circuit image may be an image that visually represents the circuit and a trajectory of a signal that has passed through the circuit.

According to the present disclosure, by the above-described configuration, it is possible to enable an operator to easily understand the control state in the control apparatus.

According to the present disclosure, it is possible to provide an abnormality diagnosis system, an abnormality diagnosis method, and a program capable of performing an abnormality diagnosis for facilities without using a different method for each of the facilities.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 shows an abnormality diagnosis system according to a first embodiment;

FIG. 2 shows examples of circuit images that can be displayed in a control apparatus according to the first embodiment;

FIG. 3 shows examples of circuit images that can be displayed in the control apparatus according to the first embodiment;

FIG. 4 shows a configuration of an abnormality diagnosis system according to the first embodiment;

FIG. 5 shows a flowchart of an abnormality diagnosis method performed by the abnormality diagnosis system 1 according to the first embodiment;

FIG. 6 shows diagrams for explaining the abnormality diagnosis method according to the first embodiment;

FIG. 7 shows diagrams for explaining the abnormality diagnosis method according to the first embodiment;

FIG. 8 shows diagrams for explaining the abnormality diagnosis method according to the first embodiment;

FIG. 9 shows diagrams for explaining the abnormality diagnosis method according to the first embodiment; and

FIG. 10 shows diagrams for explaining an abnormality diagnosis method according to a comparative example.

### DESCRIPTION OF EMBODIMENTS

### First Embodiment

Embodiments according to the present disclosure will be described hereinafter with reference to the drawings. The following description and the drawings are partially omitted and simplified as appropriate for clarifying the explanation. Further, the same elements are denoted by the same reference numerals (or symbols) throughout the drawings, and redundant descriptions thereof are omitted as appropriate.

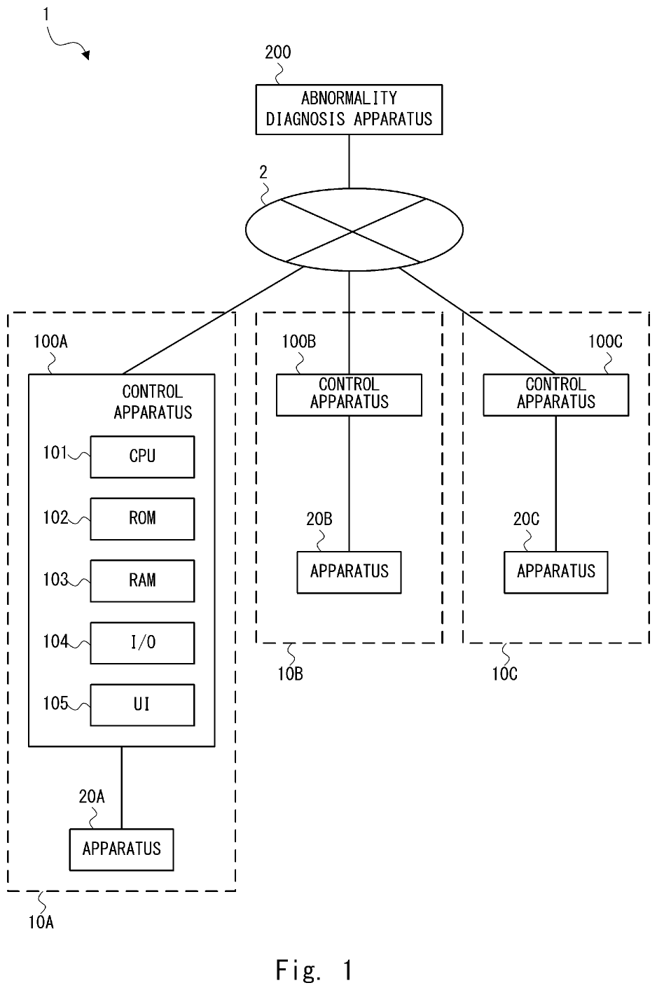

FIG. 1 shows an abnormality diagnosis system 1 according to a first embodiment. The abnormality diagnosis system 1 includes a plurality of facilities 10 and an abnormality diagnosis apparatus 200. The abnormality diagnosis system 1 is installed, for example, in a factory where a plurality of manufacturing operations are performed. In FIG. 1, the abnormality diagnosis system 1 includes three facilities 10, i.e., facilities 10A to 10C. However, the abnormality diagnosis system 1 may include any number of facilities 10.

Each of the facilities 10 includes an apparatus 20 and a control apparatus 100. In FIG. 1, the facility 10A includes an apparatus 20A and a control apparatus 100A. The facility 10B includes an apparatus 20B and a control apparatus 100B. The facility 10C includes an apparatus 20C and a control apparatus 100C. The apparatus 20 includes, for example, a detector such as a sensor, and a manufacturing apparatus such as an industrial robot. The apparatus 20 is installed, for example, in the vicinity of a manufacturing line for vehicles.

The control apparatus 100 controls the apparatus 20 in the facility 10. The control apparatus 100 controls the operation of the apparatus 20, which is a manufacturing apparatus, by using detection information detected by the apparatus 20, which is a detector. The control apparatus 100 is installed, for example, in the vicinity of the apparatus 20 of a respective one of the facilities 10. Each of the control apparatuses 100 is connected to the abnormality diagnosis apparatus 200 through a wired or wireless network 2 so that they can communicate with each other.

The abnormality diagnosis apparatus 200 is configured to diagnose each of the facilities 10 to detect an abnormality thereof (i.e., to perform an abnormality diagnosis for each of the facilities 10). The abnormality diagnosis apparatus 200 has, for example, a function as a computer. The abnormality diagnosis apparatus 200 can be installed, for example, in a central monitoring room or the like of the factory where the abnormality diagnosis system 1 is installed. The abnormality diagnosis apparatus 200 will be described later.

Note that a different manufacturing operation can be performed in each of the facilities 10. Further, a different apparatus 20 and a different type of a control apparatus 100 are provided in each of the facilities 10. Therefore, the apparatuses 20A to 20C could be different from each other. Further, the types of the control apparatuses 100A to 100C could be different from each other. For example, the control apparatuses 100A to 100C could be manufactured by manufacturers different from each other. Note that the plurality of facilities 10 do not have to be provided in one factory, but may be provided in a plurality of factories that are located physically away from each other.

The control apparatus 100 has, for example, a function as a computer. The control apparatus 100 is, for example, a PLC (Programmable Logic Controller). The control apparatus 100 may be incorporated into a control panel or an operation panel installed in the vicinity of the apparatus 20. The control apparatus 100 includes, as hardware, a CPU (Central Processing Unit) 101, a ROM (Read Only Memory) 102, a RAM (Random Access Memory) 103, an I/O (Input/Output) 104, and a UI (User Interface) 105.

The CPU 101 has a function as a processing device (processor) that performs control processing and arithmetic processing. The ROM 102 has a function as a storage that stores a control program(s), an arithmetic program(s), and the like executed by the CPU 101. The RAM 103 has a function as a memory that temporarily stores processing data and the like. The I/O 104 is an input/output apparatus, and receives data and signals from the outside such as from the apparatus 20, the abnormality diagnosis apparatus 200, and the like, and outputs data and signals to the outside. The UI 105 is composed of an input device such as a keyboard, and an output device such as a display device. Note that the UI 105 may be formed as a touch panel in which an input device and an output device are integrated with each other. Further, the UI 105 may be physically independent of the control apparatus 100 which may be configured by a control panel or the like. Note that the ROM 102 is configured so as to store an operating program for controlling the apparatus 20.

Note that the control apparatus 100 controls the apparatus 20 by using a logical circuit (logic circuit) that is implemented by an operating program stored in the ROM 102. For example, the logical circuit is, but is not limited to, a ladder circuit. Further, the logical circuit may be one that can be changed (i.e., modified) by changing a program code. However, when the logical circuit is changed, the control performed by the control apparatus 100 is changed. Therefore, in general, the logical circuit is not changed unless the control performed by the control apparatus 100 is changed. Further, the control apparatus 100 can display a circuit image that visually represents the logical circuit and a control state in the logical circuit by using the UI 105. In the circuit image, the control state is superimposed on the logical circuit. In this way, an operator (a person in charge of safety maintenance) can visually check the control state of the facility 10 related to the control apparatus 100. The circuit image is, for example, a ladder diagram, but is not limited thereto. Note that the control state indicates what kind of control is being performed by the control apparatus 100.

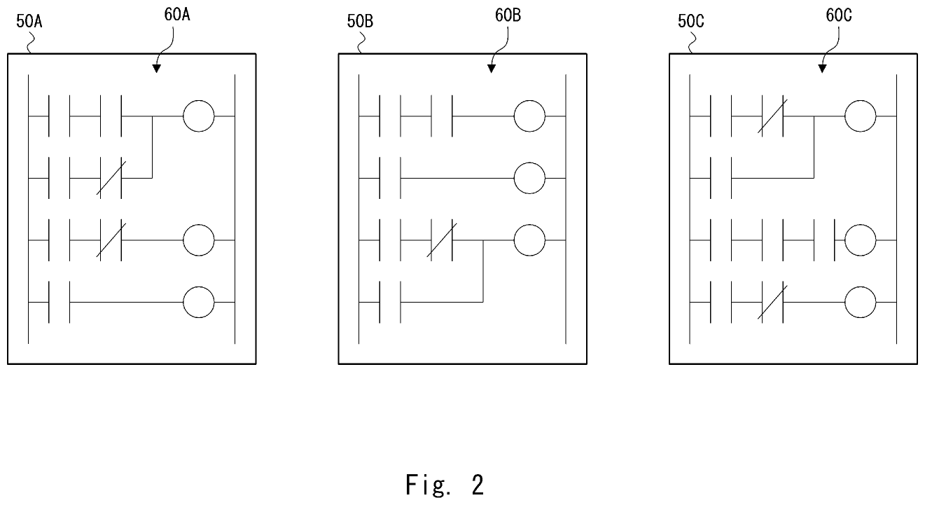

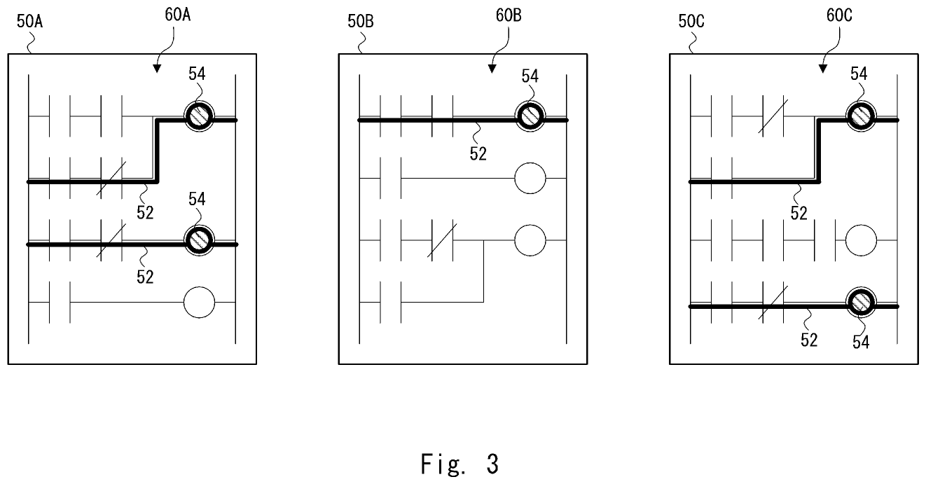

FIGS. 2 and 3 show examples of circuit images that can be displayed in the control apparatus 100 according to the first embodiment. FIG. 2 illustrates circuit images 50 representing logical circuits, and FIG. 3 illustrates circuit images 50 in which control states are superimposed on the logical circuits. Each of the circuit images 50 visually represents a logical circuit 60 in a respective one of the control apparatuses 100. A circuit image 50A represents a logical circuit 60A in the control apparatus 100A. A circuit image 50B represents a logical circuit 60B in the control apparatus 100B. A circuit image 50C represents a logical circuit 60C in the control apparatus 100C. Note that FIG. 3 shows examples of the circuit images 50 when the respective facilities 10 are in a normal state. The “normal state” is a state in which no abnormality has occurred. Further, the “abnormality” includes a state in which maintenance, safety maintenance, suspension (e.g., a temporary stop), or the like of the facility 10 is necessary, and a state in which a sign indicating that maintenance, safety maintenance, suspension, or the like will be necessary has appeared. The “abnormality” may be determined as appropriate by an operation manager (a person in charge of safety maintenance). Note that, in the following description, the term “image” also means “image data representing an image” which is a subject of information processing.

The logical circuit 60 is composed of a plurality of circuit elements (buses, rungs, contacts, output coils, etc.). The buses are indicated by vertical lines at the left and right ends of the logical circuit 60. The rungs are indicated by horizontal lines between the buses. Each of the contacts is indicted by a pair of opposed vertical lines on the rung. A contact indicated just by a pair of opposed vertical lines is a contact a. Further, a contact indicated by a pair of opposed vertical lines and oblique lines is a contact b. Each of the output coils (loads) is indicated by a circle on the rung. Further, in FIG. 3, each circuit image 50 visually represents a trajectory 52 of a signal that has passed through a logical circuit 60 (rung) (hereinafter also referred to as a signal trajectory 52). Further, each circuit image 50 also visually represents a normal symbol 54 on a circuit element representing an output coil. The normal symbol 54 indicates that the output coil has appropriately operated on the signal trajectory 52 (rung). The signal trajectory 52 and the normal symbol 54 indicate a control state in the logical circuit 60.

For example, when the background of the circuit image 50 is white, the logical circuit 60 is displayed in a display form such as a thin black line in the circuit image 50. Further, in the circuit image 50, the signal trajectory 52 and the normal symbol 54 are displayed in a display form that indicates a normal state, such as being displayed in green. Note that the display form indicating a normal state is not limited to green. The signal trajectory 52 and the normal symbol 54 can be displayed in a display form by which a difference from the display form of the logical circuit 60 is visually apparent. As shown in FIG. 3, the signal trajectory 52 may be indicated by a thick solid line, and the normal symbol 54 may be indicated by predetermined hatching.

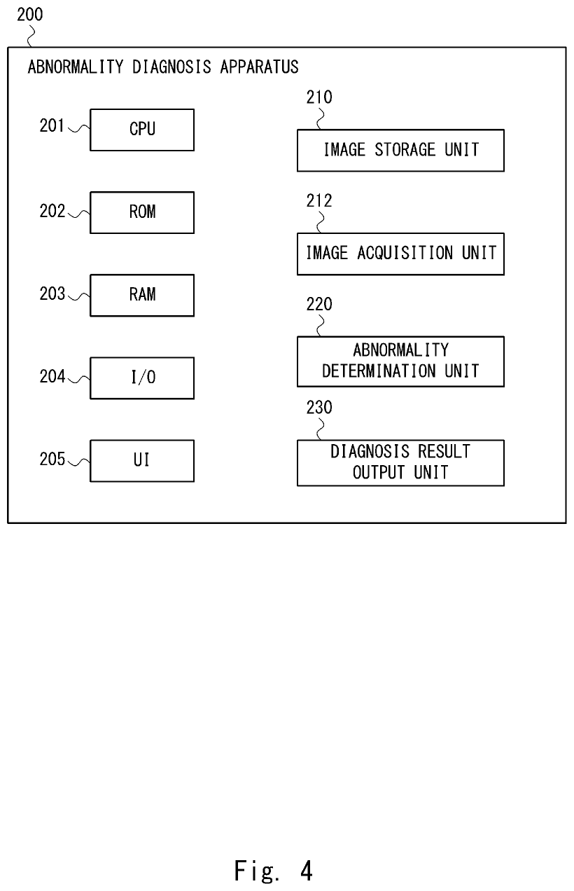

FIG. 4 shows a configuration of an abnormality diagnosis apparatus 200 according to the first embodiment. The abnormality diagnosis apparatus 200 includes, as a hardware configuration, a CPU 201, a ROM 202, a RAM 203, an I/O 204, and a UI 205.

The CPU 201 has a function as a processing device (processor) that performs control processing and arithmetic processing. The ROM 202 has a function as a storage that stores a control program(s), an arithmetic program(s), and the like executed by the CPU 201. The RAM 203 has a function as a memory that temporarily stores processing data and the like. The I/O 204 is an input/output apparatus, and receives data and signals from the outside such as from the control apparatus 100 and the like, and outputs data and signals to the outside. The UI 205 is composed of an input device such as a keyboard, and an output device such as a display device. Note that the UI 205 may be formed as a touch panel in which an input device and an output device are integrated with each other.

Further, the abnormality diagnosis apparatus 200 includes, as its components, an image storage unit 210, an image acquisition unit 212, an abnormality determination unit 220, and a diagnosis result output unit 230. Note that at least one of the components of the abnormality diagnosis apparatus 200 may be implemented by an apparatus different from the abnormality diagnosis apparatus 200 (e.g., by the control apparatus 100). Each of the components of the abnormality diagnosis apparatus 200 is not limited to one that is implemented by physically one apparatus, but may be implemented by a plurality of apparatuses, for example, through cloud computing. The function of each of the components of the abnormality diagnosis apparatus 200 will be described later.

Note that these components can be implemented as the CPU 201 executes a program(s) stored in the ROM 202. Further, the abnormality diagnosis apparatus 200 may store a necessary program(s) in an arbitrary non-volatile recording medium in advance, and install the program(s) as required. Note that each component of the abnormality diagnosis apparatus 200 is not limited to one that is implemented by software as described above, but may be implemented by hardware such as some circuit element or the like. Further, each component of the abnormality diagnosis apparatus 200 may be implemented by using an integrated circuit that can be programed by a user, such an FPGA (field-programmable gate array) or a microcontroller. In this case, a program composed of the above-described components (i.e., a program by which the above-described components are implemented) may be implemented (i.e., executed) by using such an integrated circuit.

The image storage unit 210 stores, for each of the control apparatuses 100, a circuit image 50 in a state in which the facility 10 corresponding to that control apparatus 100 is in a normal state as a normal circuit image (normal circuit image data). Note that the normal circuit images of the control apparatuses 100 could differ from one another. The normal circuit image can be prepared for each of the control apparatuses 100 and stored for each of the control apparatuses 100.

The normal circuit image may be acquired, for example, by storing in advance a pattern of the circuit image 50 in the state where the facility 10 (control apparatus 100) is in a normal state. For example, the normal circuit image may be acquired by storing in advance all the patterns of the circuit images 50 in the state where the facility 10 (control apparatus 100) is in a normal state. Further, for example, the normal circuit image may be acquired by learning in advance the circuit image 50 in the state where the facility 10 is in a normal state through machine learning or the like. In this case, the normal circuit image corresponds to learning data. Note that in the case where each of the facilities 10 (each of the control apparatuses 100) performs a plurality of manufacturing processes and the circuit images 50 in a normal state in these manufacturing processes are different from each other, there may be a plurality of normal circuit images each for a respective one of the control processes corresponding to the respective manufacturing processes. Note that even in this case, in the plurality of normal circuit images for a given control apparatus 100, although its signal trajectories 52 and normal symbols 54 (control states) could be different from one another, its logical circuits 60 could be identical to each other.

The image acquisition unit 212 acquires, from each of the control apparatuses 100, a circuit image to be diagnosed (a first circuit image), which is a circuit image 50 that is a subject of the abnormality diagnosis (i.e., the diagnosis to detect an abnormality). Specifically, the image acquisition unit 212 receives, by controlling the I/O 204, the circuit image to be diagnosed (circuit image data to be diagnosed) from the control apparatus 100 through the network 2. In this case, the control apparatus 100 may transmit one circuit image to the abnormality diagnosis apparatus 200 through the network 2 by using the I/O 104.

Note that the image acquisition unit 212 may acquire, as the circuit image to be diagnosed, the circuit image 50 that is currently displayed in the control apparatus 100. Further, the image acquisition unit 212 may continuously acquire the circuit image to be diagnosed. Alternatively, the image acquisition unit 212 may acquire the circuit image to be diagnosed at a predetermined time or at predetermined intervals.

The abnormality determination unit 220 determines whether or not an abnormality has occurred in the facility 10 (control apparatus 100) by using the circuit image to be diagnosed and the normal circuit image. Specifically, the abnormality determination unit 220 determines whether or not there is a deviation between the circuit image to be diagnosed related to a certain control apparatus 100 and the normal circuit image related to that control apparatus 100. Then, when the abnormality determination unit 220 has determined that there is a deviation, it determines that an abnormality has occurred in the facility 10 related to the control apparatus 100.

Further, when the abnormality determination unit 220 has determined that an abnormality has occurred in the facility 10, it determines whether or not the circuit 60 in the circuit image to be diagnosed differs from the logical circuit 60 in the normal circuit image. Then, when the abnormality determination unit 220 has determined that the logical circuit 60 in the circuit image to be diagnosed differs from the logical circuit 60 in the normal circuit image, it determines that the logical circuit 60 has been tampered with in the control apparatus 100. On the other hand, when the abnormality determination unit 220 has determined the logical circuit 60 in the circuit image to be diagnosed does not differ from the logical circuit 60 in the normal circuit image, it determines that the abnormality has occurred due to a faulty operation of the facility. In other words, the abnormality determination unit 220 determines that an abnormality has occurred because an operating condition has not been satisfied in the logical circuit 60 due to a faulty operation of the facility.

The diagnosis result output unit 230 outputs a result of the determination made by the abnormality determination unit 220, i.e., a diagnosis result (a result of an abnormality diagnosis). Specifically, the diagnosis result output unit 230 makes the UI 205 display the diagnosis result therein. Alternatively, the diagnosis result output unit 230 may output, by controlling the I/O 204, data indicating the diagnosis result to the control apparatus 100 that is the subject of the diagnosis. In this way, the diagnosis result may be displayed in the UI 105 of the control apparatus 100.

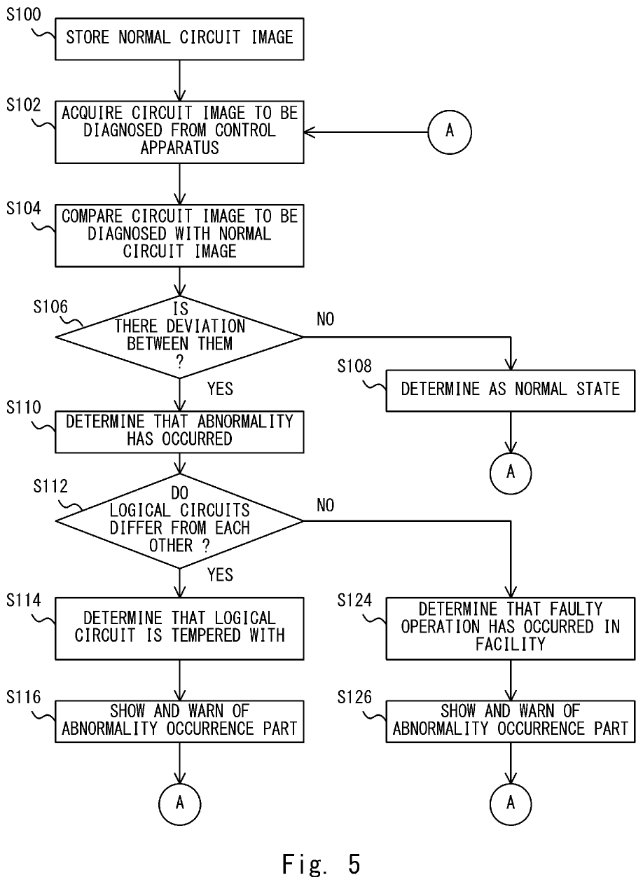

FIG. 5 is a flowchart showing an abnormality diagnosis method performed by the abnormality diagnosis system 1 according to the first embodiment. The processes shown in FIG. 5 are mainly performed by the abnormality diagnosis apparatus 200. Further, the processes (an abnormality diagnosis process) shown in FIG. 5 can be performed independently for each of the control apparatuses 100. The processes shown in FIG. 5 for two or more control apparatuses 100 may be performed in parallel with each other. In the following description, although the abnormality diagnosis process for the control apparatus 100A, in which the facility to be diagnosed is the facility 10A (control apparatus 100A), will be described as appropriate, the same applies to each of the other control apparatuses 100.

Firstly, the image storage unit 210 stores a normal circuit image (step S100). Note that, as described above, the image storage unit 210 separately stores a normal circuit image(s) for each of the control apparatuses 100A to 100C. This process is performed before the abnormality diagnosis.

The image acquisition unit 212 acquires a circuit image to be diagnosed from the control apparatus 100 (step S102). For example, when the abnormality diagnosis apparatus 200 performs an abnormality diagnosis for the control apparatus 100A (facility 10A), the image acquisition unit 212 receives, as the circuit image to be diagnosed, a circuit image 50 that is currently displayed in the control apparatus 100A from the control apparatus 100A. The same applies to each of the other control apparatuses 100.

The abnormality determination unit 220 compares the circuit image to be diagnosed with the normal circuit image (step S104). For example, when the abnormality diagnosis apparatus 200 performs an abnormality diagnosis for the control apparatus 100A (facility 10A), the abnormality determination unit 220 extracts (i.e., retrieves) a normal circuit image related to the control apparatus 100A from the image storage unit 210. Then, the abnormality determination unit 220 compares the extracted (i.e., retrieved) normal circuit image of the control apparatus 100A with the circuit image to be diagnosed acquired from the control apparatus 100A.

The abnormality determination unit 220 determines whether or not there is a deviation between the circuit image to be diagnosed and the normal circuit image (step S106). That is, the abnormality determination unit 220 determines whether or not the circuit image to be diagnosed matches the normal circuit image. When the circuit image to be diagnosed matches the normal circuit image, the abnormality determination unit 220 determines that there is no deviation between the circuit image to be diagnosed and the normal circuit image. On the other hand, when the circuit image to be diagnosed does not match the normal circuit image, the abnormality determination unit 220 determines that there is a deviation between the circuit image to be diagnosed and the normal circuit image. Note that in the case where there are a plurality of normal circuit images, the abnormality determination unit 220 may determine whether or not the circuit image to be diagnosed matches a normal circuit image corresponding to the manufacturing process (control process) during which that circuit image to be diagnosed was acquired. Alternatively, the abnormality determination unit 220 may determine whether or not the circuit image to be diagnosed matches any of the plurality of normal circuit images. Then, when the circuit image to be diagnosed matches at least one of the plurality of normal circuit images, the abnormality determination unit 220 may determine that the circuit image to be diagnosed matches the normal circuit image.

Note that for the method for determining whether or not a circuit image to be diagnosed matches a normal circuit image, for example, the below-described method may be used. For example, the abnormality determination unit 220 may determine that the circuit image to be diagnosed matches the normal circuit image when, for each of all the coordinates (i.e., all the pixels) in both circuit images 50 (i.e., in the circuit image to be diagnosed and the normal circuit image), the pixel values at corresponding coordinates (i.e., at the same coordinates) match each other.

Alternatively, the abnormality determination unit 220 may determine that the circuit image to be diagnosed matches the normal circuit image when, in both circuit images 50, the number of pixels which are located at the same coordinates, but of which the pixel values do not match each other is equal to or smaller than a predetermined threshold. Alternatively, the abnormality determination unit 220 may calculate, for each of all the coordinates (i.e., all the pixels) in both circuit images 50, a difference between pixel values at the same coordinates, and determine that the circuit image to be diagnosed matches the normal circuit image when the differences at all the coordinates (i.e., all the pixels) are equal to or smaller than a predetermined threshold. Alternatively, the abnormality determination unit 220 may calculate, for each of all the coordinates (i.e., all the pixels) in both circuit images 50, a difference between pixel values at the same coordinates, and determine that the circuit image to be diagnosed matches the normal circuit image when the number of pixels of which the differences are equal to or smaller than a predetermined threshold is equal to or smaller than a predetermined threshold. Alternatively, the abnormality determination unit 220 may calculate, for each of all the coordinates (i.e., all the pixels) in both circuit images 50, a difference between pixel values at the same coordinates, and determine that the circuit image to be diagnosed matches the normal circuit image when the sum of the absolute values of the differences (e.g., the root mean square of the differences) is equal to or smaller than a predetermined threshold. Note that the aforementioned thresholds are defined so that the circuit image to be diagnosed and the normal circuit image are considered to match each other when the difference between them is constituted solely by errors at a noise level. Therefore, these thresholds are very small. That is, when the logical circuits and the control states of both circuit images 50 are the same as each other, a parameter such as the above-described difference or the number of pixels does not exceed its threshold. Conversely, the above-described thresholds are set so that parameters exceed these thresholds when the logical circuits and the control states of both circuit images 50 are different from each other.

When it is determined that there is no deviation between the circuit image to be diagnosed and the normal circuit image (No at step S106), the abnormality determination unit 220 determines that the facility 10 (control apparatus 100) to be diagnosed is in a normal state (step S108). Then, the process returns to the step S102, and the abnormality diagnosis process is repeated for the facility 10 (control apparatus 100) to be diagnosed.

On the other hand, when it is determined that there is a deviation between the circuit image to be diagnosed and the normal circuit image (Yes at S106), there is a very high possibility that the control apparatus 100 is performing control that differs from that in the normal state. Therefore, the abnormality determination unit 220 determines that an abnormality has occurred in the facility 10 (control apparatus 100) to be diagnosed (step S110). Then, the abnormality determination unit 220 determines the type of the abnormality (tampering of the logical circuit 60 or a faulty operation of the facility 10) through a process described below.

The abnormality determination unit 220 determines whether or not the logical circuit 60 in the circuit image to be diagnosed differs from the logical circuit 60 in the normal circuit image (step S112). Specifically, when the facility to be diagnosed is the facility 10A (control apparatus 100A), the abnormality determination unit 220 compares the logical circuit 60 in the circuit image to be diagnosed acquired from the control apparatus 100A with the logical circuit 60 in the normal circuit image corresponding to the control apparatus 100A. Then, the abnormality determination unit 220 determines whether or not the images of these logical circuits 60 differ from each other. That is, in the process in the step S112, the signal trajectory 52 and the normal symbol 54 are excluded from what are compared to each other. Note that the method for determining whether or not the images of the logical circuits 60 differ from each other may be substantially the same as the method used in the step S106.

When it is determined that the logical circuit 60 in the circuit image to be diagnosed differs from the logical circuit 60 in the normal circuit images (Yes at S112), the abnormality determination unit 220 determines that the logical circuit 60 have been tampered with in the control apparatus 100 (step S114). That is, in general, in a given control apparatus 100, the logical circuit 60 is not changed unless the control to be performed is changed. If the logical circuit 60 in the circuit image to be diagnosed nevertheless differs from the logical circuit 60 in the normal circuit image, it means that there is a very high possibility that the logical circuit 60 of that control apparatus 100 has been tampered with. The tampering of the logical circuit 60 could be carried out, for example, by a malicious third party by tampering with a program code for implementing the logical circuit 60 stored in the control apparatus 100. Alternatively, the tampering of the logical circuit 60 could be carried out, for example, by cracking (i.e., a cyber-attack) through a network.

Further, the abnormality determination unit 220 determines that a part of the logical circuit 60 in the circuit image to be diagnosed that differs from that of the logical circuit 60 in the normal circuit image is an abnormality occurrence part where the abnormality has occurred. The abnormality determination unit 220 outputs the result of the diagnosis (the determination result) to the diagnosis result output unit 230. Note that the diagnosis result includes information indicating the abnormality occurrence part.

The diagnosis result output unit 230 shows the abnormality occurrence part and outputs a warning indicating that the abnormality has occurred (step S116). Specifically, when the facility to be diagnosed is the facility 10A (control apparatus 100A), the diagnosis result output unit 230 makes the UI 205 output a warning indicating that the abnormality has occurred in the facility 10A (control apparatus 100A). The diagnosis result output unit 230 may make the UI 205, which serves as a display device, display an image representing a warning. Alternatively, the diagnosis result output unit 230 may make the UI 205, which serves as a speaker, output a sound indicating a warning. Further, the diagnosis result output unit 230 may make the UI 105 of the control apparatus 100A output a warning (the same applies to other abnormality occurrence parts described later).

Further, the diagnosis result output unit 230 makes the UI 205 output the abnormality occurrence part along with the warning. For example, the diagnosis result output unit 230 performs control so that the part in the circuit image to be diagnosed that differs from that in the logical circuit 60 in the normal circuit image is displayed in a display form different from that for the signal trajectory 52 and the normal symbol 54. For example, the diagnosis result output unit 230 may display the part in the circuit image to be diagnosed that differs from that in the logical circuit 60 in the normal circuit image, in a warning color such as red.

By outputting the diagnosis result as described above, an operator can easily understand that tampering of the logical circuit 60 has occurred in a certain control apparatus 100, and which part in the logical circuit 60 has been tampered with. Therefore, the operator can correct the tampered logical circuit 60 and take preventive measures against tampering, such as enhancing the security.

Then, the process returns to the step S102, and the abnormality diagnosis process is repeated for the facility 10 (control apparatus 100) to be diagnosed.

On the other hand, when it is determined that the logical circuit 60 in the circuit image to be diagnosed does not differ from the logical circuit 60 in the normal circuit image (No at S112), the abnormality determination unit 220 determines that an abnormality has occurred due to a faulty operation of the facility 10 (step S124). That is, the abnormality determination unit 220 determines that the abnormality has occurred because an operating condition has not been satisfied in the logical circuit 60 due to a faulty operation of the facility. In this case, it is highly likely that the part in the circuit image to be diagnosed that differs from that in the normal circuit image corresponds to the control state, i.e., to the signal trajectory 52 (and normal symbol 54). The fact that the signal trajectory 52 (and the normal symbol 54) differs from that (those) in the normal circuit image means that an operating condition, which would be satisfied in the normal state, has not been satisfied. Further, the operating condition is for the operation of the facility 10 (a sensor or the like). Therefore, when the part in the circuit image to be diagnosed that differs from that in the normal circuit image corresponds to the signal trajectory 52 (and the normal symbol 54), the abnormality determination unit 220 determines that the abnormality has occurred because an operating condition has not been satisfied in the logical circuit 60 due to a faulty operation of the facility. The faulty operation could be caused, for example, by an abnormality in detection information of the apparatus 20, which serves as a sensor, a failure of the apparatus 20, a fall of an object conveyed by the apparatus 20, which serves as a conveyance apparatus, and a disconnection (e.g., breaking) of a wiring line between the apparatus 20 and the control apparatus 100.

Further, the abnormality determination unit 220 determines the part in the circuit image to be diagnosed that differs from that in the normal circuit image as an abnormality occurrence part where the abnormality has occurred. The abnormality determination unit 220 outputs the result of the diagnosis (the determination result) to the diagnosis result output unit 230. Note that the diagnosis result includes information indicating the abnormality occurrence part.

The diagnosis result output unit 230 shows the abnormality occurrence part and outputs a warning indicating that the abnormality has occurred (step S126). Specifically, similarly to the process in the step S116, when the facility to be diagnosed is the facility 10A (control apparatus 100A), the diagnosis result output unit 230 makes the UI 205 output a warning indicating that the abnormality has occurred in the facility 10A (control apparatus 100A). Further, the diagnosis result output unit 230 makes the UI 205 output the abnormality occurrence part along with the warning. For example, the diagnosis result output unit 230 performs control so that the part in the circuit image to be diagnosed that differs from that in the signal trajectory 52 and the normal symbol 54 in the normal circuit image is displayed in a display form different from that for the signal trajectory 52 and the normal symbol 54. For example, the diagnosis result output unit 230 may display the part in the circuit image to be diagnosed that differs from that in the normal circuit image, in a warning color such as red.

By outputting the diagnosis result as described above, an operator can easily understand that a failure in the facility, related to a certain control apparatus 100 has occurred, and which apparatus 20 the occurred faulty operation is related to. Therefore, the operator can take appropriate measures against the faulty operation.

Then, the process returns to the step S102, and the abnormality diagnosis process is repeated for the facility 10 (control apparatus 100) to be diagnosed.

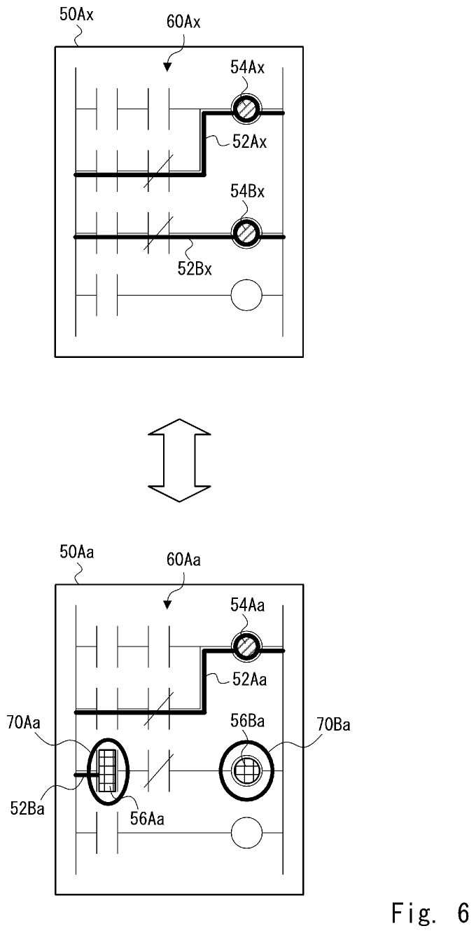

FIGS. 6 to 9 show diagrams for explaining an abnormality diagnosis method according to the first embodiment. A comparison between a normal circuit image and a circuit image to be diagnosed will be described with reference to FIGS. 6 to 9. An abnormality diagnosis in the control apparatus 100A will be described with reference to FIGS. 6 to 8.

FIG. 6 shows a normal circuit image 50Ax in the control apparatus 100A, and a circuit image to be diagnosed 50Aa at a given point of time in the control apparatus 100A. In the normal circuit image 50Ax, a logical circuit 60Ax, signal trajectories 52Ax and 52Bx, and normal symbols 54Ax and 54Bx are shown. Further, in the circuit image to be diagnosed 50Aa, a logical circuit 60Aa, signal trajectories 52Aa and 52Ba, a normal symbol 54Aa, and abnormal symbols 56Aa and 56Ba are shown. The abnormal symbol 56 indicates a control state in the logical circuit 60.

Note that the abnormal symbol 56 indicates an abnormality on the logical circuit 60. For example, the abnormal symbol 56 indicates an abnormality related to the input/output of a signal. For example, when the abnormal symbol 56 is shown on a circuit element indicating a contact a, the abnormal symbol 56 indicates such an abnormality that since an input corresponding to this contact, which should be obtained under normal conditions, has not been obtained, the contact has not been turned on. Further, for example, when the abnormal symbol 56 is shown on a circuit element indicating a contact b, the abnormal symbol 56 indicates such an abnormality that since an input corresponding to this contact, which should not be obtained under normal conditions, has be obtained, the contact has not been turned on. Further, for example, when the abnormal symbol 56 is shown on a circuit element indicating an output coil, the abnormal symbol 56 indicates such an abnormality that this output coil, which should be activated under normal conditions, has not been activated. The abnormal symbol 56 is displayed in a display form indicating an abnormality, such as being displayed in red. Note that the display form indicating an abnormal state is not limited to red. The abnormal symbol 56 can be displayed in a display form by which a difference from the display form of the signal trajectory 52 and the normal symbol 54 is visually apparent.

In the example shown in FIG. 6, the abnormality determination unit 220 compares the normal circuit image 50Ax with the circuit image to be diagnosed 50Aa (S104 in FIG. 5), and determines that an abnormality has occurred in the facility 10A because there is a deviation between these images (Yes at S106, S110). Further, the abnormality determination unit 220 compares the logical circuit 60Ax in the normal circuit image 50Ax with the logical circuit 60Aa in the circuit image to be diagnosed 50Aa, and determines that these images match each other (No at S112). Therefore, the abnormality determination unit 220 determines that the abnormality has not occurred due to tampering of the logical circuit 60A, but has occurred due to a faulty operation (S124).

Note that the abnormality determination unit 220 compares the control state in the normal circuit image 50Ax with that in the circuit image to be diagnosed 50Aa. Specifically, the abnormality determination unit 220 compares the signal trajectories 52Ax and 52Bx, and the normal symbols 54Ax and 54Bx in the normal circuit image 50Ax with the signal trajectories 52Aa and 52Ba, and the normal symbol 54Aa and the abnormal symbols 56Aa and 56Ba in the circuit image to be diagnosed 50Aa. Then, the abnormality determination unit 220 determines that the signal trajectory 52Ax matches the signal trajectory 52Aa, but the signal trajectory 52Ba does not match the signal trajectory 52Bx. Further, the abnormality determination unit 220 determines that the normal symbol 54Ax matches the normal symbol 54Aa, but there is no symbol in the circuit image to be diagnosed 50Aa that matches the normal symbol 54Bx. Further, the abnormality determination unit 220 determines that there are no symbols in the normal circuit image 50Ax that correspond to the abnormal symbols 56Aa and 56Ba.

The abnormality determination unit 220 regards the above-described difference between the normal circuit image 50Ax and the circuit image to be diagnosed 50Aa as an abnormality occurrence part, and output it as a result of the diagnosis to the diagnosis result output unit 230. The diagnosis result output unit 230 may display abnormality occurrence part marks 70Aa and 70Ba that indicate the abnormality occurrence parts at at least parts of the locations (i.e., parts), in the circuit image to be diagnosed 50Aa, that differ from those in the normal circuit image 50Ax (S126). The abnormality occurrence part marks 70Aa and 70Ba may be displayed, for example, in red or the like.

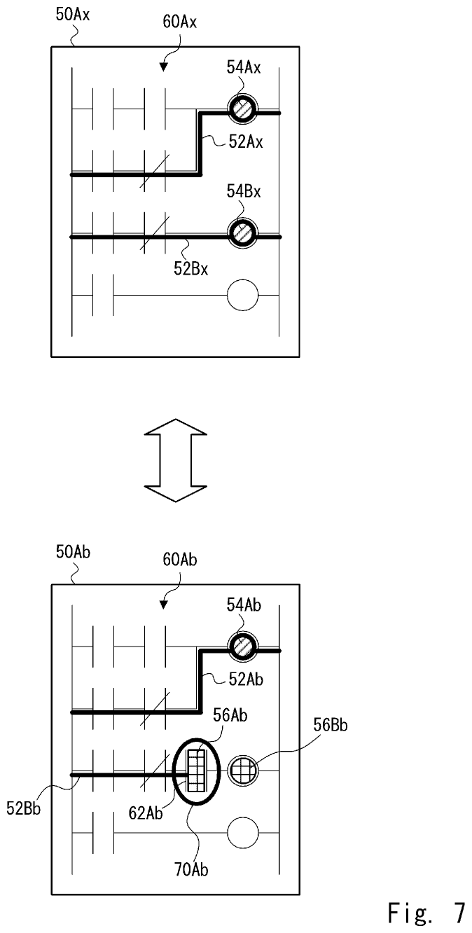

FIG. 7 shows a normal circuit image 50Ax in the control apparatus 100A and a circuit image to be diagnosed 50Ab at a given point of time in the control apparatus 100A. The normal circuit image 50Ax is the same as that shown in FIG. 6. In the circuit image to be diagnosed 50Ab, a logical circuit 60Ab, signal trajectories 52Ab and 52Bb, a normal symbol 54Ab, and abnormal symbols 56Ab and 56Bb are shown.

In the example shown in FIG. 7, the abnormality determination unit 220 compares the normal circuit image 50Ax with the circuit image to be diagnosed 50Ab (S104 in FIG. 5), and determines that an abnormality has occurred in the facility 10A because there is a deviation between these images (Yes at S106, S110). Further, the abnormality determination unit 220 compares the logical circuit 60Ax in the normal circuit image 50Ax with the logical circuit 60Ab in the circuit image to be diagnosed 50Ab, and determines that these images do not match each other (Yes at S112). Therefore, the abnormality determination unit 220 determines that an abnormality due to tampering of the logical circuit 60A has occurred (S114).

Note that the abnormality determination unit 220 determines that there is a circuit element 62Ab, in the logical circuit 60Ab, that does not exist in the logical circuit 60Ax. The circuit element 62Ab is a circuit element that has been added by tampering. Note that, in the example shown in FIG. 7, since the circuit element 62Ab corresponding to the contact is not turned on, the abnormal symbol 56Ab is superimposed on this circuit element 62Ab, thus showing a state in which the signal trajectory 52Bb is interrupted at the circuit element 62Ab. Further, similarly to FIG. 6, the abnormal symbol 56Bb is superimposed on an output coil disposed on the rung on which the circuit element 62Ab is disposed. That is, in the example shown in FIG. 7, in addition to the abnormality due to the tampering of the logical circuit 60, another abnormality that has been caused by the fact that an operating condition has not been satisfied has also occurred.

The abnormality determination unit 220 regards the above-described difference between the logical circuit 60Ax in the normal circuit image 50Ax and the logical circuit 60Ab in the circuit image to be diagnosed 50Ab as an abnormality occurrence part, and output it as a result of the diagnosis to the diagnosis result output unit 230. The diagnosis result output unit 230 may display an abnormality occurrence part mark 70Ab that indicates the abnormality occurrence part in the circuit element 62Ab (S116). The abnormality occurrence part mark 70Ab may be displayed, for example, in red or the like. Further, the type of the abnormality (tampering with the logical circuit) that occurred in the example shown in FIG. 7 differs from the type of the abnormality (faulty operation) that occurred in the example shown in FIG. 6. Therefore, the abnormality occurrence part mark 70Ab may be displayed in a form different from that for the abnormality occurrence part marks 70Aa and 70Ba shown in FIG. 6. For example, an abnormality due to tampering may be considered to be more serious than an abnormality due to a faulty operation from the point of view that there has been an intervention by a malicious third party. Therefore, the abnormality occurrence part mark 70Ab may be displayed in a form that is more conspicuous than that for the abnormality occurrence part marks 70Aa and 70Ba shown in FIG. 6. For example, the abnormality occurrence part mark 70Ab may be displayed in a blinking manner.

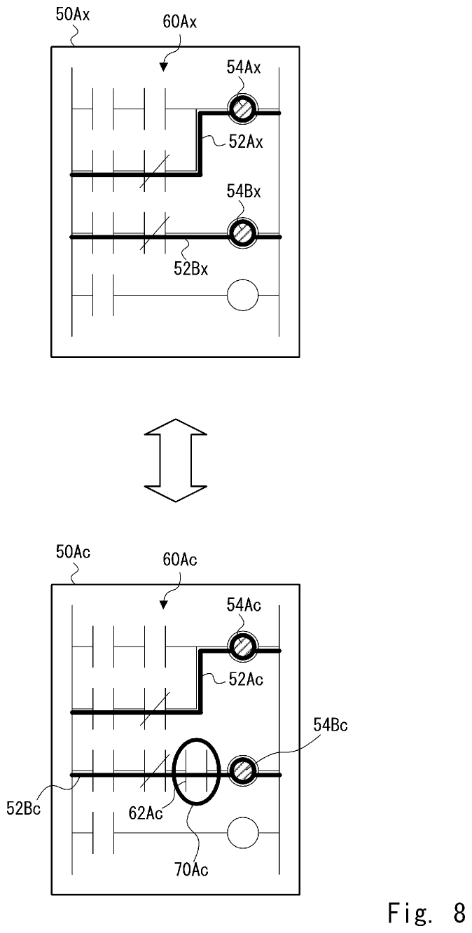

FIG. 8 shows the normal circuit image 50Ax in the control apparatus 100A and the circuit image to be diagnosed 50Ac at a given point of time in the control apparatus 100A. The normal circuit image 50Ax is the same as that shown in FIG. 6. In the circuit image to be diagnosed 50Ac, a logical circuit 60Ac, signal trajectories 52Ac and 52Bc, and normal symbols 54Ac and 54Bc are shown.

In the example shown in FIG. 8, the abnormality determination unit 220 compares the normal circuit image 50Ax with the circuit image to be diagnosed 50Ac (S104 in FIG. 5), and determines that an abnormality has occurred in the facility 10A because there is a deviation between these images (Yes at S106, S110). Further, the abnormality determination unit 220 also compares the logical circuit 60Ax in the normal circuit image 50Ax with the logical circuit 50Ac in the circuit image to be diagnosed 60Ac, and determines that these images do not match each other (YES of S112). Therefore, the abnormality determination unit 220 determines that an abnormality due to tampering of the logical circuit 60A has occurred (S114).

Note that the abnormality determination unit 220 compares the logical circuit 60Ax in the normal circuit image 50Ax with the logical circuit 60Ac in the circuit image to be diagnosed 50Ac. Then, the abnormality determination unit 220 determines that there is a circuit element 62Ac, in the logical circuit 60Ac, that does not exist in the logical circuit 60Ax. The circuit element 62Ac is a circuit element that has been added by tampering. Note that, in the example shown in FIG. 8, since the circuit element 62Ac corresponding to the contact is in an on-state, a state in which the signal trajectory 52Bc passes through this circuit element 62Ac is shown. Therefore, the normal symbol 54Bc is superimposed on an output coil disposed on the rung on which the circuit element 62Ac is disposed. That is, in the example shown in FIG. 8, unlike the example shown in FIG. 7, any abnormality that has been caused by the fact that an operating condition has not been satisfied has not occurred. Therefore, the control state of the circuit image to be diagnosed 50Ac matches (i.e., is the same as) the control state of the normal circuit image 50Ax.

The abnormality determination unit 220 regards the above-described difference between the logical circuit 60Ax in the normal circuit image 50Ax and the logical circuit 60Ac in the circuit image to be diagnosed 50Ac as an abnormality occurrence part, and output it as a result of the diagnosis to the diagnosis result output unit 230. The diagnosis result output unit 230 may display an abnormality occurrence part mark 70Ac that indicates the abnormality occurrence part in the circuit element 62Ac (S116). The abnormality occurrence part mark 70Ac may be displayed, for example, in red or the like. Further, similarly to FIG. 7, the abnormality occurrence part mark 70Ac may be displayed in a form different from that for the abnormality occurrence part marks 70Aa and 70Ba shown in FIG. 6.

In the example shown in FIG. 8, although the tampering of the logical circuit 60 has occurred, any abnormality that has been caused by the fact that an operating condition has not been satisfied has not occurred. In the first embodiment, even in such a case, it is possible to appropriately diagnose the facility 10 (control apparatus 100) to detect an abnormality thereof. Therefore, an operator can understand that tampering of the logical circuit 60 has occurred even if the control apparatus 100 is apparently operating in a normal state.

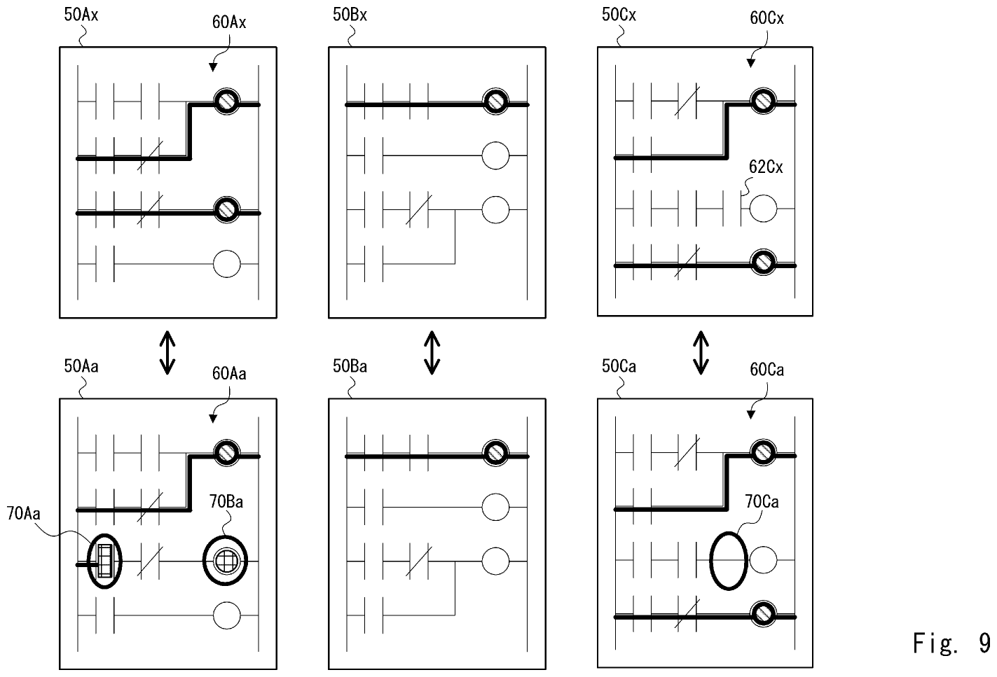

FIG. 9 shows an example case where the abnormality diagnosis apparatus 200 performs an abnormality diagnosis for each of the control apparatuses 100A to 100C. As for the control apparatus 100A (facility 10A), the abnormality diagnosis is similar to that in the example shown in FIG. 6, and therefore the description thereof is omitted. As for the control apparatus 100B (facility 10B), the abnormality determination unit 220 compares the normal circuit image 50Bx with the circuit image to be diagnosed 50Ba (S104 in FIG. 5), and determines that the facility 10B is in a normal state because there is no deviation between these images (No at S106, S108).

As for the control apparatus 100C (facility 10C), the abnormality determination unit 220 compares the normal circuit image 50Cx with the circuit image to be diagnosed 50Ca (S104 in FIG. 5), and determines that an abnormality has occurred in the facility 10C because there is a deviation between these images (Yes at S106, S110). Further, the abnormality determination unit 220 compares the logical circuit 60Cx in the normal circuit image 50Cx with the logical circuit 60Ca in the circuit image to be diagnosed 50Ca, and determines that these images do not match each other (YES of S112). Therefore, the abnormality determination unit 220 determines that an abnormality due to tampering of the logical circuit 60C has occurred (S114). Specifically, the abnormality determination unit 220 determines that the circuit element 62Cx which exists in the logical circuit 60Cx in the normal circuit image 50Cx does not exist in the logical circuit 60Ca in the circuit image to be diagnosed 50Ca. The circuit element 62Cx is a circuit element that has been removed by tampering. In this case, the diagnosis result output unit 230 may display an abnormality occurrence part mark 70Ca indicating an abnormality occurrence part at a part where the circuit element 62Cx has been removed in the circuit image to be diagnosed 50Ca (the logical circuit 60Ca) (S116).

### Comparative Example

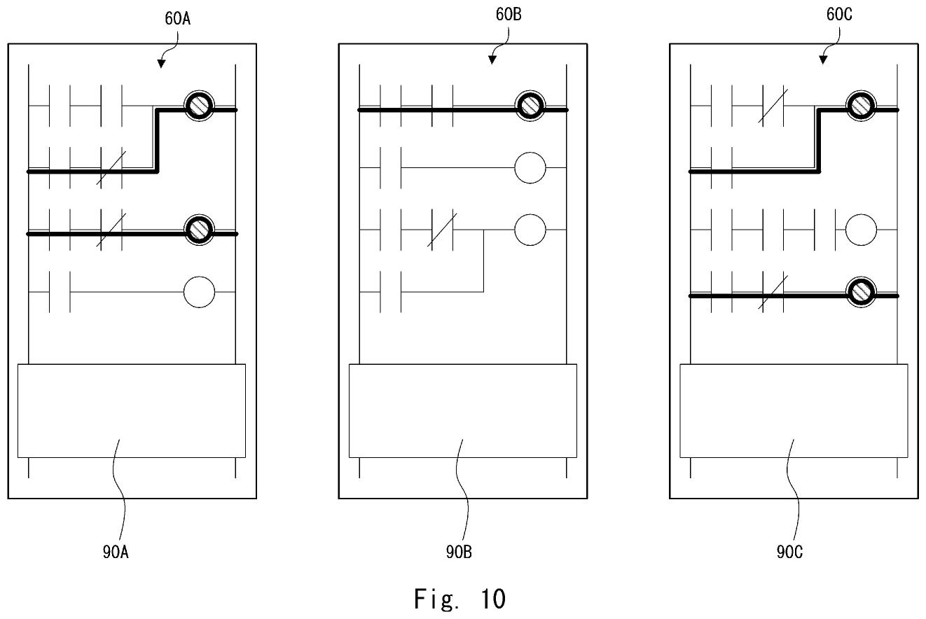

FIG. 10 shows diagrams for explaining an abnormality diagnosis method according to a comparative example. In the comparative example, in order to detect an abnormality in each of control apparatuses 100, it is necessary to incorporate an abnormality detection circuit 90 in a logical circuit 60 in each of the control apparatuses 100. As shown in the example shown in FIG. 10, an abnormality detection circuit 90A is incorporated in a logical circuit 60A related to the control apparatus 100A. Similarly, an abnormality detection circuit 90B is incorporated in a logical circuit 60B related to the control apparatus 100B. An abnormality detection circuit 90C is incorporated in a logical circuit 60C related to the control apparatus 100C.

It should be noted that the logical circuits 60 in the control apparatuses 100 could differ from one another. Further, the programming languages for describing the logical circuits 60 in the control apparatuses 100 could differ from one another. Therefore, the abnormality detection circuits 90A to 90C could differ from one another. In other words, when an abnormality diagnosis is performed in each of the control apparatuses 100 in the comparative example, it is necessary to create an abnormality detection circuit 90 for each of the control apparatuses 100 according to a different algorithm. Further, it is very complicated to prepare a different abnormality detection circuit 90 for each of the control apparatuses 100.

In contrast, the abnormality diagnosis system 1 according to the first embodiment is configured to, for each of the control apparatuses 100, acquire a circuit image to be diagnosed of that control apparatus 100, and compare the circuit image to be diagnosed of the control apparatus 100 with a normal circuit image thereof. Further, the abnormality diagnosis system 1 is configured to determine that an abnormality has occurred when there is a deviation between the circuit image to be diagnosed and the normal circuit image. In the first embodiment, since an abnormality diagnosis can be performed by comparing images as described above, it is possible to diagnose each of the control apparatuses 100 (each of the facilities 10) to detect an abnormality thereof without setting a different algorithm for each of the control apparatuses 100 (each of the facilities 10). In other words, a normal circuit image is prepared for each of the control apparatuses 100 in advance. Then, it is possible to, for each of the control apparatuses 100, diagnose that control apparatus 100 to detect an abnormality thereof by comparing a circuit image to be diagnosed acquired from that control apparatus 100 with a normal circuit image thereof. Therefore, the abnormality diagnosis system 1 according to the first embodiment can diagnose facilities 10 to detect an abnormality thereof without using a different method for each of the facilities 10.

Further, the abnormality diagnosis system 1 according to the first embodiment includes the abnormality diagnosis apparatus 200, which is an apparatus different from the control apparatuses 100. Further, the abnormality diagnosis apparatus 200 acquires a circuit image to be diagnosed from each of the control apparatuses 100, and determines, for each of the control apparatuses 100, whether or not an abnormality has occurred in that control apparatus 100 by compares the circuit image to be diagnosed of that control apparatus 100 with a normal circuit image thereof. Note that the abnormality diagnosis apparatus 200 can be installed in a central monitoring room or the like that is located away from the working site in the factory. Therefore, it is relatively easy to use a computer having high processing power for the abnormality diagnosis apparatus 200. Therefore, by the above-described configuration, it is possible to appropriately perform an abnormality diagnosis even when the control apparatus 100 is an apparatus having relatively low processing power, such as a PLC.

Further, the abnormality diagnosis system 1 according to the first embodiment is configured to determine, when it has been determined that an abnormality has occurred in the facility 10, whether or not the logical circuit in the circuit image to be diagnosed differs from that in the normal circuit image. Then, when it has been determined that that logical circuit in the circuit image to be diagnosed differs from that in the normal circuit image, the abnormality diagnosis system 1 determines that the logical circuit has been tampered with in the control apparatus 100. As described above, under normal conditions, the logical circuit is not altered (e.g., changed) during the control of the control apparatus 100. The fact that the logical circuit nevertheless differs from that in the normal state, i.e., the logical circuit has been changed from that in the normal state, means that there is a very high possibility that the logical circuit has been tampered with. Therefore, by the above-described configuration, it is also possible to perform a diagnosis as to the type of the abnormality, such as tampering of the circuit. Further, even in the case where the logical circuit is tampered with but no abnormality has occurred (no abnormal symbol is displayed) on the circuit image, it is possible to detect an abnormality due to tampering of the logical circuit.

Further, the abnormality diagnosis system 1 according to the first embodiment is configured to determine, when it is determined that an abnormality has occurred in the facility 10 and the logical circuit in the circuit image to be diagnosed does not differ from that in the normal circuit image, that the abnormality has occurred because an operating condition has not been satisfied in the logical circuit. The situation in which the circuit image to be diagnosed differs from the normal circuit image, but the logical circuits therein do not differ from each other is a situation in which the control state in the circuit image to be diagnosed differs from that in the normal circuit image. Therefore, by the above-described configuration, it is possible to appropriately detect an abnormality that has been caused by the fact that an operating condition has not been satisfied in the logical circuit, i.e., appropriately detect an abnormality due to a faulty operation of the facility 10.

Further, in the abnormality diagnosis system 1 according to the first embodiment, the circuit image is an image that visually represents a logical circuit and a signal trajectory, i.e., the trajectory of a signal that has passed through the logical circuit. By the above-described configuration, it is possible to enable an operator to easily understand the control state in the control apparatus 100.

### Modified Example

Note that the present disclosure is not limited to the above-described embodiments, and they can be modified as appropriate without departing from the scope and spirit of the present disclosure. For example, the order of steps in the above-shown flowchart can be changed as appropriate. Further, one or a plurality of steps in the flowchart may be omitted. For example, in the flowchart shown in FIG. 5, the processes in the steps S116 and S126 may be omitted. Further, in the case where only whether or not an abnormality has occurred is determined, rather than determining the type of the abnormality (determining tampering of the logical circuit or a failure in the facility), the processes in and after the step S112 may be unnecessary.

Further, although the abnormality diagnosis method shown in FIG. 5 is performed by the abnormality diagnosis apparatus 200 in the above-described first embodiment, the present disclosure is not limited to such a configuration. Each of the control apparatuses 100 may perform an abnormality diagnosis for that control apparatus 100 (facility 10). However, the processing power of the control apparatus 100, which is, for example, a PLC, is often lower than that of the abnormality diagnosis apparatus 200. Therefore, by having the abnormality diagnosis apparatus 200 perform an abnormality diagnosis for each of the control apparatuses 100, it is possible to perform abnormality diagnoses more efficiently.

Further, although a normal circuit image is composed of a logical circuit(s), a signal trajectory(ies) corresponding to a control state(s), and a normal symbol(s) in the above-described embodiment, the present disclosure is not limited to such a configuration. The control state included in the normal circuit image may indicate an abnormality. That is, an abnormal symbol may be shown in the normal circuit image.

In the above program the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM, CD-R (compact disc recordable), CD-R/W, and semiconductor memories (such as mask ROM, PROM (Programmable ROM), EPROM (Erasable PROM), flash ROM, RAM, etc.). Examples of transitory computer readable media include electric signals, optical signals, and electromagnetic waves. Transitory computer readable media can provide the program to a computer via a wired communication line (e.g. electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An abnormality diagnosis system comprising:
an image acquisition unit configured to acquire a first circuit image, the first circuit image being a circuit image visually representing a logical circuit for control in a control apparatus and a control state in the circuit, and being a subject of an abnormality diagnosis, the control apparatus being configured to control an apparatus in a facility; and
an abnormality determination unit configured to determine whether or not there is a deviation between the first circuit image acquired by the image acquisition unit and a normal circuit image, and determine, when it is determined that there is a deviation, that an abnormality has occurred in the facility, the normal circuit image being the circuit image in a state in which the facility related to the control apparatus corresponding to the first circuit image is in a normal state.

2. The abnormality diagnosis system according to claim 1, wherein
when it is determined that an abnormality has occurred in the facility, the abnormality determination unit determines whether or not the circuit in the first circuit image differs from that in the normal circuit image, and
when it is determined the circuit in the first circuit image differs from that in the normal circuit image, the abnormality determination unit determines that the circuit has been tampered with in the control apparatus.

3. The abnormality diagnosis system according to claim 2, wherein when it is determined that an abnormality has occurred in the facility, but it is determined that the circuit in the first circuit image does not differ from that in the normal circuit image, the abnormality determination unit determines that the abnormality has occurred because an operating condition has not been satisfied in the circuit.

4. The abnormality diagnosis system according to claim 1, wherein the circuit image is an image that visually represents the circuit and a trajectory of a signal that has passed through the circuit.

5. An abnormality diagnosis method comprising:
acquiring a first circuit image, the first circuit image being a circuit image visually representing a logical circuit for control in a control apparatus and a control state in the circuit, and being a subject of an abnormality diagnosis, the control apparatus being configured to control an apparatus in a facility; and
determining whether or not there is a deviation between the acquired first circuit image and a normal circuit image, and determining, when it is determined that there is a deviation, that an abnormality has occurred in the facility, the normal circuit image being the circuit image in a state in which the facility related to the control apparatus corresponding to the first circuit image is in a normal state.

6. A non-transitory computer readable medium storing a program causing a computer to perform:
acquiring a first circuit image, the first circuit image being a circuit image visually representing a logical circuit for control in a control apparatus and a control state in the circuit, and being a subject of an abnormality diagnosis, the control apparatus being configured to control an apparatus in a facility; and
determining whether or not there is a deviation between the acquired first circuit image and a normal circuit image, and determining, when it is determined that there is a deviation, that an abnormality has occurred in the facility, the normal circuit image being the circuit image in a state in which the facility related to the control apparatus corresponding to the first circuit image is in a normal state.
